(19) United States
(12) Patent Application Publication
(10) Pub. No.: US 2005/0226639 A1
(43) Pub. Date: Oct. 13, 2005

(54) Method of transmitting digital signals over an optical transmission system

(75) Inventors: Pascal Pecci, Chilly-Mazarin (FR); Stephanie Lanne, Paris (FR); Gabriel Charlet, Villiers-Le-Bacle (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/068,991

(22) Filed: Mar. 2, 2005

(30) Foreign Application Priority Data
Apr. 8, 2004 (EP) 04 290 973.9

(51) Int. Cl. H04B 10/04

(52) U.S. Cl. 398/188

(57) ABSTRACT

A method of transmitting digital signals over an optical transmission system is described. The method comprises the following steps: generating a signal according to the differential phased shift keying (DPSK) format, forwarding the DPSK signal to an optical delay filter, and using an output signal of the optical delay filter as a signal according to the phase shaped binary transmission (PSBT) format.

### TECHNICAL FIELD

The invention relates to a method of transmitting digital signals over an optical transmission system. The invention is based on a priority application EP 04 290 973.9 which is hereby incorporated by reference.

### BACKGROUND OF THE INVENTION

U.S. Pat. No. 5,920,416 discloses a method of transmitting digital signals over an optical transmission system using phase modulation. To compensate the chromatic disperson produced by a fiber, a phase-shift is applied to the optical signal within each time cell in which the respective binary digit is low and within each time cell that precedes or follows a time cell in which the binary digit is high. This method is known as phase-shaped binary transmission (PSBT) and falls into the category of duobinary non-return-to-zero modulation formats.

In U.S. Pat. No. 5,920,416, the phase-shift is generated by an electrical control circuit and an optical phase modulator. The electrical control circuit requires a low-pass filter, e.g. a Bessel filter. The phase modulator may comprise a Mach Zehnder type interferometer.

### SUMMARY OF THE INVENTION

It is an object of the present invention to provide a method of transmitting digital signals over an optical transmission system using the phase-shaped binary transmission format of U.S. Pat. No. 5,920,416 and requiring less components compared to the prior art.

The invention solves this object by a method of transmitting digital signals over an optical transmission system comprising the following steps: generating a signal according to the differential phased shift keying (DPSK) format, forwarding the DPSK signal to an optical delay filter, and using an output signal of the optical delay filter as a signal according to the phase shaped binary transmission (PSBT) format, by an optical transmitter for an optical transmission system for transmitting digital signals comprising: means for generating a signal according to the differential phased shift keying (DPSK) format, an optical delay filter for receiving the DPSK signal and for generating an output signal according to the phase shaped binary transmission (PSBT) format and by an optical transmission system for transmitting digital signals comprising: means for generating a signal according to the differential phased shift keying (DPSK) format, an optical delay filter for receiving the DPSK signal and for generating an output signal according to the phase shaped binary transmission (PSBT) format.

The invention first generates a signal according to the differential phased shift keying (DPSK) format. Then, this DPSK signal is forwarded to an optical delay filter. And then, the invention uses an output signal of the optical delay filter as a signal according to the phase shaped binary transmission (PSBT) format.

Compared to the prior art, the invention does not require an electrical low-pass filter or the like. As a result, the invention provides the advantage that the PSBT signal is generated with less components.

In an advantageous embodiment of the invention, the optical delay filter is a Mach Zehnder filter wherein the PSBT signal is provided at a constructive port of the Mach Zehnder filter. Thus, a very effective solution is provided for generating the PSBT signal.

In another advantageous embodiment of the invention, the optical delay filter has a time delay xT, with x being a value between 0.5 and 1.0 and T being the time duration of a time cell of a single binary digit. In particular, in connection with a bit rate of 43.06 GBit/sec, the optical delay filter has a time delay of 0.86T.

### BRIEF DESCRIPTION OF THE DRAWINGS

Further features, applications and advantages of the invention will become apparent from the following description of exemplary embodiments of the invention which are shown in the drawings. There, all described and shown features themselves or in any combination represent the subject matter of the invention, independently of their wording in the description or their representation in the drawings and independently of their combination in the claims or the dependencies of the claims.

FIG. 1 shows a schematic block diagram of a first embodiment of a method of transmitting digital signals over an optical transmission system according to the invention, and FIG. 2 shows a schematic block diagram of a second embodiment of a method of transmitting digital signals over an optical transmission system according to the invention.

### DETAILED DESCRIPTION OF PREFERRED EMBODIMENTS

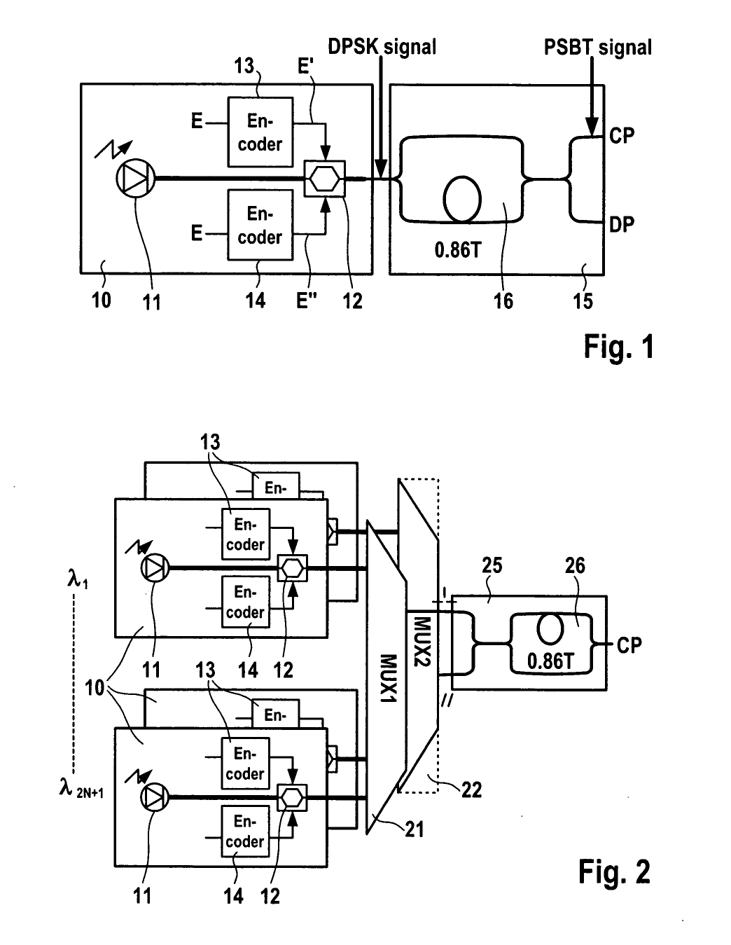

In FIG. 1, a signal according to the known, so-called differential phased shift keying (DPSK) format is generated by a block 10. The block 10 is followed by a block 15. Both blocks 10, 15 may be part of an optical transmitter or an optical transmission system for transmitting digital signals.

The block 10 comprises a light emitting source 11 for generating an optical signal, and an optical modulator 12 for receiving and influencing the optical signal. Two electrical encoders 13, 14 are provided which receive a binary input signal E with a given bit rate, e.g 43.06 GBit/sec, and which influence the optical modulator 12 with their output signals E′, E″.

The optical modulator 12 outputs an optical signal depending on the signals E′, E″ received from the two encoders 13, 14. In order to generate a signal in the differential phased shift keying format, the two encoders 13, 14 comprise the required algorithms. In FIG. 1, the two encoders 13, 14 work according to a so-called push-pull method. It is mentioned that the two encoders 13, 14 may be replaced by a single encoder comprising corresponding algorithms.

At the output of the optical modulator 12, a signal according to the differential phased shift keying format is present, i.e. a DPSK signal.

The block 15 comprises a passive optical delay filter 16, in particular a Mach Zehnder filter. The optical delay filter 16 receives the output signal of the optical modulator 12. The two channels of the optical delay filter 16 have a given optical time delay xT, with x being a value between 0.5 and 1.0 and T being the time duration of a time cell of a single binary digit.

With e.g. the above-mentioned given bit rate of 43.06 GBit/sec and a grid value of 50 GHz according to the ITU standard (ITU=international telecommunication union), the value x is selected to be 0.86, i.e. the time delay between the two channels of the optical delay filter 16 is 0.86T.

The optical delay filter 16 provides two output ports, a constructive port CP and a destructive port DP. At the constructive port CP of the optical delay filter 16, a signal according to the phase-shaped binary transmission format of U.S. Pat. No. 5,920,416 is present, i.e. a PSBT signal. At the destructive port, a duobinary return-to-zero signal is generated.

The PSBT signal of the constructive port CP of the optical delay filter 16 has proved to provide a very good resistance with regard to chromatic dispersion produced by a fiber. The method of generating the afore-mentioned PBST signal has proved to be very effective, in particular it does not require an electrical filter within the encoders 13, 14.

In FIG. 2, a signal according to the differential phased shift keying (DPSK) format is generated several times for different wavelengths λ₁ to λ_{2N+1} of the light emitting source 11. For that purpose, an equal number of identical blocks 10 is provided. With regard to these blocks 10, reference is made to FIG. 1 and the above description. The output signals of the number of blocks 10, i.e. the DPSK signals corresponding to the different wavelengths λ₁ to λ_{2N+1}, are multiplexed by two multiplexers 21, 22 relating to the two polarizations of the optical signals. The output signals of these two multiplexers 21, 22 are forwarded to a block 25 which comprises a passive optical delay filter 26, in particular a Mach Zehnder filter.

The optical delay filter 26 of FIG. 2 is similar to the optical delay filter 16 of FIG. 1 with the only difference that the optical delay filter 26 of FIG. 2 receives not only one, but two DPSK signals, i.e. the two output signals of the two multiplexers 21, 22.

At the constructive port CP of the optical delay filter 26, a signal according to the phase-shaped binary transmission format of U.S. Pat. No. 5,920,416 is present, i.e. a PSBT signal. The method of generating the afore-mentioned PBST signal for different wavelengths λ₁ to λ_{2N+1} of the light emitting source has proved to be very effective, in particular it only requires a single optical delay filter.

1. A method of transmitting digital signals over an optical transmission system comprising the following steps:
generating a signal according to the differential phased shift keying (DPSK) format,
forwarding the DPSK signal to an optical delay filter, and
using an output signal of the optical delay filter as a signal according to the phase shaped binary transmission (PSBT) format.

2. The method of claim 1 comprising the following further steps:
forwarding a signal of a light emitting source to an optical modulator,
providing a binary input signal to at least one encoder,
influencing the optical modulator depending on the input signal, and
using the output signal of the optical modulator as the signal according to the differential phased shift keying (DPSK) format.

3. An optical transmitter for an optical transmission system for transmitting digital signals comprising:
means for generating a signal according to the differential phased shift keying (DPSK) format,
an optical delay filter for receiving the DPSK signal and for generating an output signal according to the phase shaped binary transmission (PSBT) format.

4. An optical transmission system for transmitting digital signals comprising:
means for generating a signal according to the differential phased shift keying (DPSK) format,
an optical delay filter for receiving the DPSK signal and for generating an output signal according to the phase shaped binary transmission (PSBT) format.

5. The transmitter of claim 3 wherein the optical delay filter has a time delay xT, with x being a value between 0.5 and 1.0 and T being the time duration of a time cell of a single binary digit.

6. The transmitter of claim 3 wherein the optical delay filter has a time delay of 0.86T, with T being the time duration of a time cell of a single binary digit.

7. The transmitter of claim 3 wherein the PSBT signal is provided at a constructive port of the optical delay filter.

8. The transmitter of claim 3 wherein the optical delay filter is a Mach Zehnder filter.

9. The transmitter of claim 3 wherein the means for generating a signal according to the differential phased shift keying (DPSK) format comprise:
a light emitting source for generating an optical signal,
an optical modulator for receiving the optical signal and for generating an output signal according to the differential phased shift keying (DPSK) format, and
at least one encoder for receiving a binary input signal and for influencing the optical modulator.

10. The transmission system of claim 4 wherein the optical delay filter has a time delay xT, with x being a value between 0.5 and 1.0 and T being the time duration of a time cell of a single binary digit

11. The transmission system of claim 4 wherein the optical delay filter has a time delay of 0.86T, with T being the time duration of a time cell of a single binary digit.

12. The transmission system of claim 4 wherein the PSBT signal is provided at a constructive port of the optical delay filter.

13. The transmission system of claim 4 wherein the optical delay filter is a Mach Zehnder filter.

14. The transmission system of claim 4 wherein the means for generating a signal according to the differential phased shift keying (DPSK) format comprise:
a light emitting source for generating an optical signal,
an optical modulator for receiving the optical signal and for generating an output signal according to the differential phased shift keying (DPSK) format, and
at least one encoder for receiving a binary input signal and for influencing the optical modulator.
